(19) United States
(12) Patent Application Publication
(10) Pub. No.: US 2013/0199863 A1
(43) Pub. Date: Aug. 8, 2013

(54) VOCATIONAL TRUCK VEHICLE

(71) Applicant: International Truck Intellectual Property Company, LLC, Lisle, IL (US)

(72) Inventor: Thomas L. Robbins, Georgetown, KY (US)

(73) Assignee: International Truck Intellectual Property Company, LLC, Lisle, IL (US)

(21) Appl. No.: 13/757,086

(22) Filed: Feb. 1, 2013

Related U.S. Application Data
(60) Provisional application No. 61/595,022, filed on Feb. 3, 2012.

(51) Int. Cl. B60K 15/067

(52) U.S. Cl. CPC B60K 15/067
USPC 180/69.4

(57) ABSTRACT

A vocational truck vehicle has a vocational body mounted on a chassis rearward of a cab and overlying at least one rear axle. A fuel storage module for storing fuel for use by an alternative-fueled combustion engine which propels the vehicle has a frame holding at least one fuel storage vessel and attached to the vocational body to locate the fuel storage module in confronting relation to a rearward-facing wall of the vocational body.

### REFERENCE TO RELATED APPLICATION AND PRIORITY CLAIM

This application claims the priority of Provisional Patent Application No. 61/595,022, filed on 03 Feb. 2012, the entire content of which is incorporated herein by reference.

### TECHNICAL FIELD

This disclosure relates to vehicles which are propelled by combustion engines, particularly to fuel storage in a truck vehicle whose propulsion engine is fueled by an alternative fuel, such as compressed natural gas (CNG).

### BACKGROUND

Gasoline and diesel fuel are historically considered conventional fuels for motor vehicles of various types. On-board storage of such liquid fuels is typically in one or more fuels tanks mounted on a chassis of a vehicle.

Alternative energy sources for operating certain motor vehicles are in use. One example of an alternative energy source is compressed natural gas (CNG). On-board storage requirements for CNG are considerably different than those for gasoline and diesel fuel. Natural gas is stored in a compressed state at pressure which is much greater than atmospheric pressure within a storage volume which is sufficient to provide a vehicle such as a large commercial truck with an acceptable driving range comparable to that obtained in vehicles using gasoline or diesel fuel.

### SUMMARY OF THE DISCLSOURE

The present disclosure relates to a vocational truck vehicle comprising a cab-chassis having a chassis, a cab mounted on the chassis at a front of the vocational truck vehicle, the chassis including at least one rear axle rearward of the cab and a combustion engine for propelling the vocational truck vehicle.

A vocational body is mounted on the chassis rearward of the cab, overlying the at least one rear axle. The vocational body has a rearward-facing wall.

A fuel storage module for storing fuel for use by the combustion engine comprises a frame which holds at least one fuel storage vessel and is attached to the vocational body to locate the fuel storage module in confronting relation to the rearward-facing wall of the vocational body.

The foregoing summary, accompanied by further detail of the disclosure, will be presented in the Detailed Description below with reference to the following drawings that are part of this disclosure.

### BRIEF DESCRIPTION OF THE DRAWINGS

FIG. 1 is a perspective view of a waste collection vehicle showing front, top, and left side.

FIG. 2 is a perspective view of the waste collection vehicle of FIG. 1 showing top, left side, and rear.

FIG. 3 is an enlarged perspective view of a tailgate at the rear of the waste collection vehicle of FIG. 2.

FIG. 4 is an exploded perspective view of the tailgate.

FIG. 5 is an enlarged fragmentary view of a portion of FIG. 4.

FIG. 6 is a schematic diagram.

### DETAILED DESCRIPTION

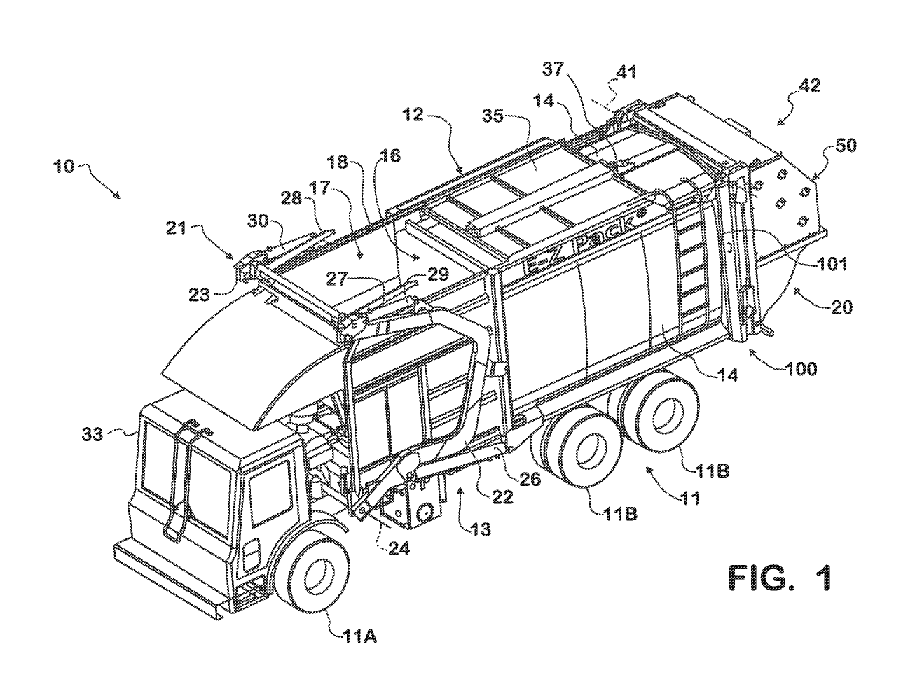

FIG. 1 shows one example of a vocational truck vehicle 10, a front loading waste collection vehicle 10, having an alternative fuel system, meaning a fuel system which is neither gasoline nor diesel.

Truck vehicle 10 comprises a cab-chassis having a chassis 11 and a cab 33 mounted on chassis 11 at the front of truck vehicle 10. Chassis 11 comprises various components, including a frame, an engine, a suspension, front steered road wheels 11A, and engine-driven rear road wheels 11B on rear tandem rear axles, which collectively form a road-operable truck vehicle.

For adapting the cab-chassis to a waste collection vocation, a waste collection body 12 is mounted on chassis 11 rearward of cab 33.

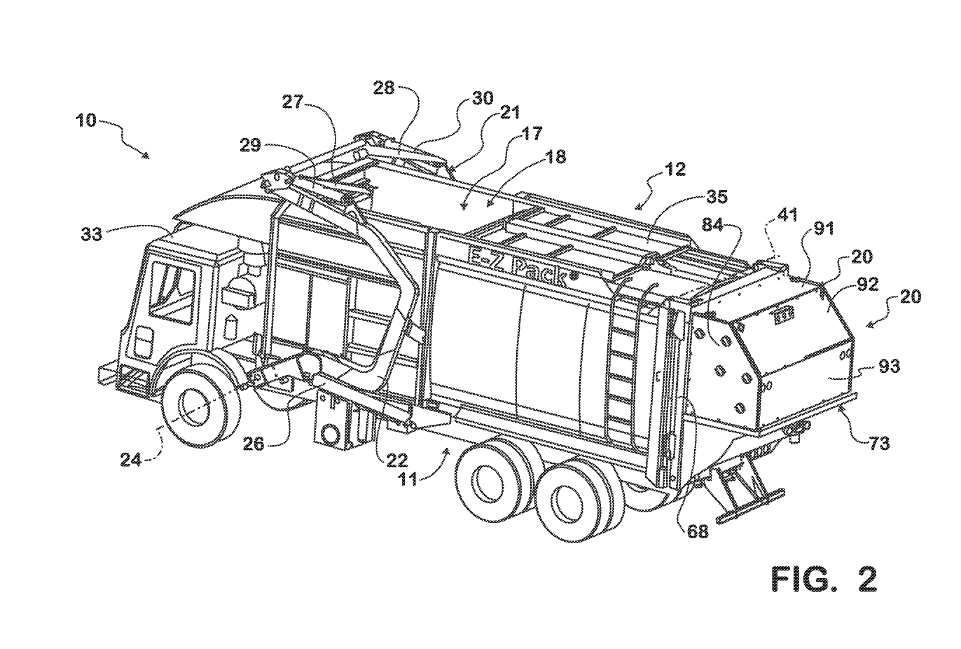

Body 12 comprises an understructure 13 and various panels, such as panels 14, cooperatively defining a waste collection space 16, a hopper 17 having a hopper opening 18 in the top of body 12 toward the front of truck vehicle 10 and a discharge opening 100 at the rear of truck vehicle 10. Body 12 comprises an upright rectangular rear frame 101 (see FIG. 2) which surrounds discharge opening 100.

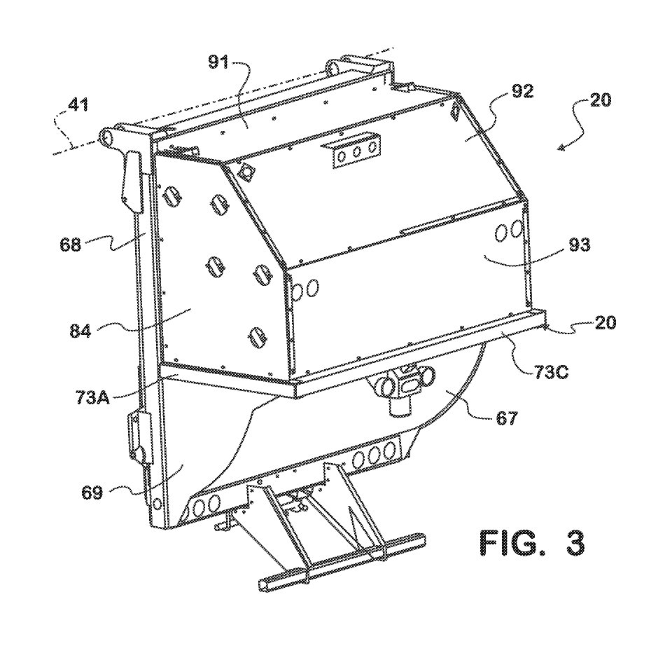

A tailgate 20 is pivotally mounted on rear frame 101 to swing about a horizontal axis 41 at the top of rear frame 101. A motive means such as hydraulic cylinder assemblies (not visible in the drawing views) are connected between tailgate 20 and rear frame 101. The motive means operates to swing tailgate 20 from a closed position (FIGS. 1, 2, and 3) to open discharge opening 100, allowing collected waste to be pushed out of waste collection space 16 through discharge opening 100. When waste collection space 16 has been emptied, the motive means operates to swing tailgate 20 downwardly to re-close discharge opening 100.

Body 12 further comprises a front loading container pickup mechanism 21 having a left pickup arm 22 and a right pickup arm 23 whose lower ends are pivotally mounted on body 12 for swinging about an axis 24.

A motive means such as a hydraulic cylinder 26 is connected between each arm 22, 23 and body 12 for pivoting pickup arms 22, 23 counterclockwise about axis 24 from a rest position shown in FIGS. 1 and 2. Container pickup mechanism 21 comprises a pickup fork having tines 27, 28, pivotally mounted on the upper ends of pickup arms 22, 23 respectively. A left hydraulic cylinder 29 is connected between tine 27 and left pickup arm 22. A right hydraulic cylinder 30 is connected between tine 28 and right pickup arm 23.

Hydraulic cylinders 29, 30 are operable to pivot the respective tines 27, 28 between a rest position shown in FIGS. 1 and 2 and an extended position for engagement of a waste container (not shown) whose contents are to be emptied into body 12. Coordinated pivoting of pickup arms 22, 23 and tines 27, 28 from their respective rest positions enables tines 27, 28 to engage an upright waste container which is in front of truck vehicle 10, and then pickup arms 22, 23 to lift the waste container and swing it over cab 33 while turning the waste container generally upside down to allow its contents to fall out of the waste container and through hopper opening 18 into hopper 17. Hydraulic cylinders 29, 30 are then operated to return the empty waste container to upright position in front of the vehicle after which tines 27, 28 are disengaged from the waste container, and they and pickup arms 22, 23 are returned to their rest positions.

Body 12 also comprises a packer mechanism (not shown) which can be extended in a direction toward the rear of truck vehicle 10 to push waste from hopper 17 into waste collection space 16. When waste collection space 16 has been fully packed, truck vehicle 10 can be driven to a suitable dump site where waste collection space 16 is emptied.

Emptying of waste collection space 16 is accomplished by swinging tailgate 20 open and operating the packer mechanism to push waste out of waste collection space 16 through discharge opening 100. After the waste has been discharged, tailgate 20 is swung closed and the packer mechanism is retracted.

Hopper opening 18 can be opened and closed by a hopper door 35 which slides in tracks between an open position shown in FIGS. 1 and 2 and a closed position covering hopper opening 18. Motive means such as a hydraulic cylinder assembly 37 is operable to move door 35 between its open and closed positions.

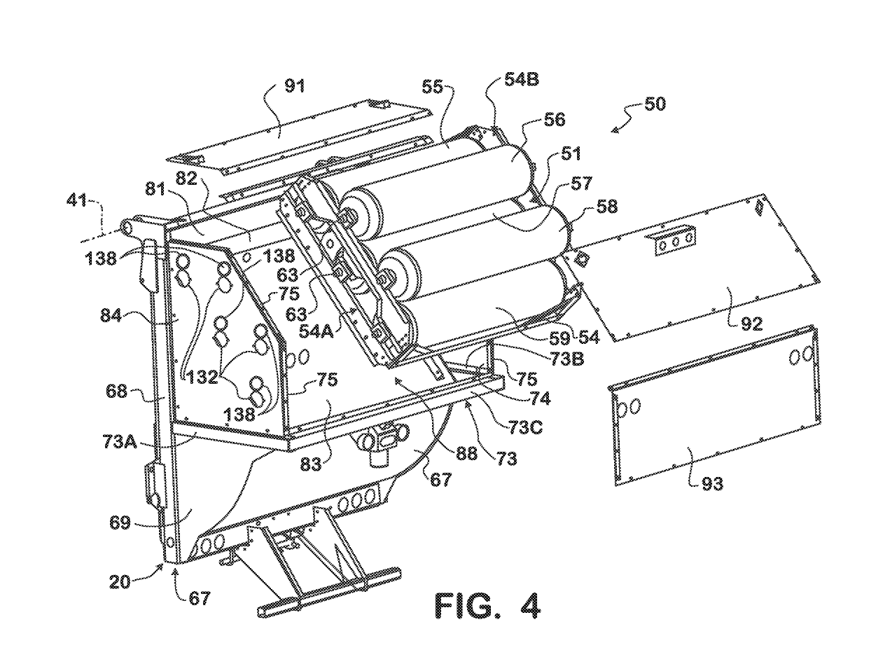

Tailgate 20 comprises a generally rectangular tailgate frame 68 that, when tailgate 20 is closed, fits to rear frame 101 to close discharge opening 100. The interior of the tailgate cavity that is open to the rear of waste collection space 16 when tailgate 20 is closed has a lower cavity portion defined by left and right lower side plates 69 extending rearward from their attachment to lower portions of vertical sides of tailgate frame 68 and by a curved bottom plate 67 extending laterally of body 12 between side plates 69. An upper cavity portion interior of the tailgate cavity that is open to the rear of waste collection space 16 when tailgate 20 is closed is defined by portions of upright side panels 74, 84 and cross panels 81, 82, 83 (FIG. 4) which extend between side panels 74, 84.

A horizontal support frame 73 extends horizontally rearward from the vertical sides of tailgate frame 68 at a common boundary of the upper and lower cavity portions of the tailgate cavity. Support frame 73 comprises side members 73A, 73B (FIG. 4) which extend rearward from attachment to respective vertical sides of tailgate frame 68 and an end member 73C which extends laterally between rear ends of side members 73A, 73B. Side panels 74, 84 attach along their horizontal bottom margins to side members 73A, 73B respectively and along their front vertical margins to respective vertical sides of tailgate frame 68. Side plates 69 attach along their horizontal top margins to side members 73A, 73B respectively. The top margin of bottom plate 67 attaches to end member 73C.

The engine of truck vehicle 10 has an alternative fuel system, one example of which is a compressed natural gas (CNG) fuel system. On-board storage 50 of CNG for use by the engine comprises at least one fuel storage cylinder mounted on a fuel pod frame 54 (FIG. 4) to form a CNG fuel pod 51. The alternative fuel system comprises various components, including connection lines, relief valves, gauges, regulators and other elements, that provide for delivery of CNG from the fuel storage cylinder or cylinders to the engine and for monitoring operation and status of the alternative fuel system.

FIG. 4 shows one example of a fuel pod 51 comprising a fuel pod frame 54 holding five fuel storage cylinders 55, 56, 57, 58, 59 which store CNG. The space between side panels 74, 84 on the exterior of cross panels 81, 82, 83 forms a fuel pod compartment 88 for fuel pod 51.

Fuel pod frame 54 comprises a base disposed against an exterior surface of cross panel 83 which inclines downwardly away from the front of truck vehicle 10. The base of fuel pod frame 54 is attached to cross panel 83. Fuel pod frame 54 also comprises side member assemblies 54A, 54B at laterally opposite sides of the base, and it is between those side member assemblies 54A, 54B that fuel storage cylinders 55, 56, 57, 58, 59 are arranged in two rows with the long dimensions of the cylinders running laterally between side member assemblies 54A, 54B.

Fuel storage cylinders 55, 57, 59 are arranged in succession side-by-side in an underlying row, and fuel storage cylinders 56, 58 are arranged side-by-side in an overlying row where each nests between a pair of fuel storage cylinders in the underlying row.

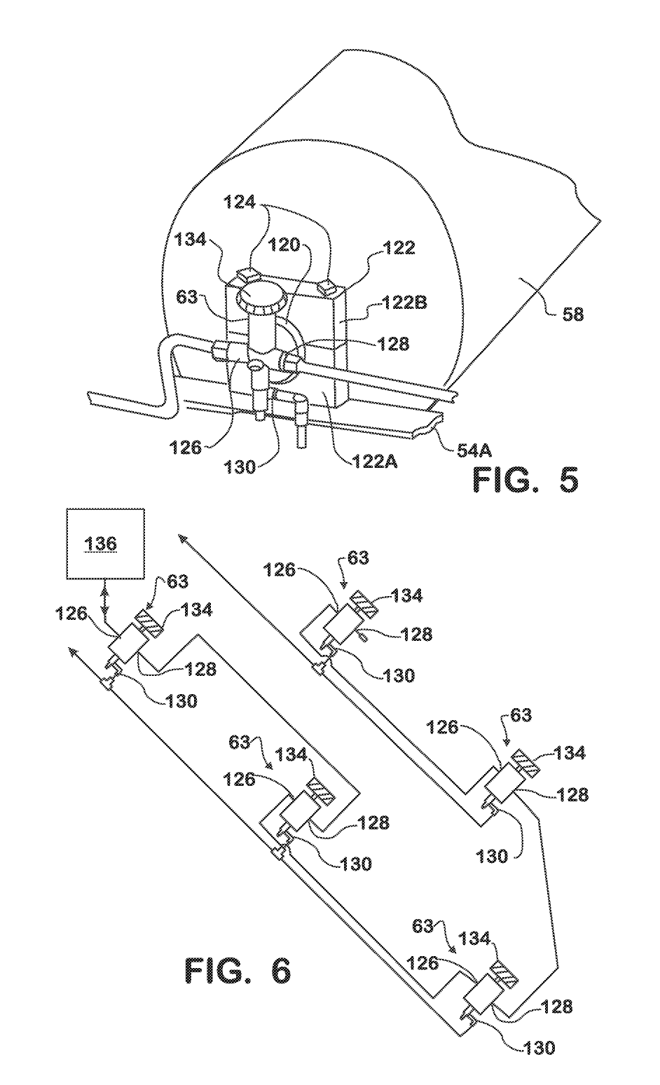

Fuel storage cylinders 55, 56, 57, 58, 59 are fit to, and removably secured in, fuel pod frame 54 via side member assemblies 54A, 54B. Various means of mounting fuel storage cylinders on a frame are known. The drawings show one example where opposite ends of each fuel storage cylinder have reduced diameter necks 120 such as the one seen in FIG. 5 which is an enlarged view in circle 5 in FIG. 4. Each neck 120 is captured by a respective yoke 122 also seen in FIG. 5. Each yoke 122 comprises an underlying part 122A mounted on a respective side member assembly 54A, 54B and an overlying part 122B. Underlying part 122A comprises a semi-circular cradle in which a neck 120 is received. Overlying part 122B comprises a semi-circular recess which fits over neck 120. Fasteners 124 fasten overlying part 122B to underlying part 122A to each side of neck 120.

Each fuel storage cylinder has a port at one lengthwise end. A respective shutoff valve 63, an example of which is seen in FIG. 5, comprises a first valve port fit to a respective cylinder port in a sealed manner. The particular shut-off valve 63 shown also comprises a second valve port 126, a third valve port 128, and a fourth valve port 130.

Shut-off valves 63 are is disposed on the interior of side panel 84, each being proximate a respective access hole 132 in side panel 84 for providing hand access for manually turning a valve handle 134 of the respective shut-off valve 63 to open and close the respective fuel storage cylinder. When open, a shut-off valve 63 allows CNG to flow into the respective fuel storage cylinder for re-filling and CNG to flow out of the respective fuel storage cylinder for operating the engine. Fuel lines (shown schematically in FIG. 6) connect to shut-off valves 63 for conveying CNG between the fuel storage cylinders and a fuel management module 136 mounted on body 12. Fuel management module 136 includes appropriate elements for controlling delivery of CNG from the fuel storage cylinders to the engine in proper quantity and pressure and controlling delivery of CNG to the fuel storage cylinders when they are being re-filled. The fuel lines are also disposed on the interior of side panel 84, but exit fuel pod compartment 88 before reaching fuel management module 136

FIG. 6 shows that the five fuel storage cylinders are connected in a chain so that when any shut-off valve 63 is open, the respective fuel storage cylinder is on-line to the chain and capable of delivering CNG for operating the engine or being re-filled with CNG during re-fueling. The last shut-off valve in the chain has its port 128 capped. Each fourth valve port 130 is a vent port which is normally closed, but opens to vent CNG when in-cylinder pressure exceeds a pressure limit.

Not shown in FIGS. 1, 2, and 3, but shown in FIG. 4, are covers 138 each of which is associated with a respective access hole 132 on the exterior of side panel 84. Covers 138 are gravity-biased to close the respective access hole 132, but can swung upward by hand to uncover the respective access hole 132 and held there to allow hand access to the respective valve handle 134.

Three cover plates 91, 92, 93 are attached to flanges 75 of right and left side plates 69 to enclose fuel pod 51 within compartment 88, with the bottom margin of cover plate 93 attaching to a flange which is parallel with end member 73C.

Placement of fuel pod 51 rearward of the tandem rear axles rather than at a location more toward the front of truck vehicle 10 moves the center of gravity of truck vehicle 10 more toward the rear, more favorably counterbalancing weight of front loading container pickup mechanism 21. That placement also leaves more space on chassis 11 for mounting other components. The drawings show the entire fuel pod rearward of the tandem rear axles.

Alternative embodiments are contemplated such as one (not illustrated) in which fuel pod 51 is configured to hold six fuel storage cylinders in an arrangement which positions a sixth fuel storage cylinder nested atop and between fuel storage cylinders 56 and 58. Pod frame 54 is modified to hold the sixth fuel storage cylinder, with other elements forming compartment 88 being re-sized as appropriate. If a customer orders a new vehicle with a five cylinder fuel pod, but finds through use that more fuel storage capacity is needed, parts can be added to fuel pod frame 54 on side member assemblies 54A, 54B between fuel storage cylinders 56 and 58 to support a pair of additional yokes 122 for mounting the sixth fuel storage cylinder. Fuel and vent lines are connected to the shut-off valve of the added fuel cylinder to place it in the chain. One or more of cover plates 91, 92, 93 bounding fuel pod compartment 88 may be modified and/or replaced.

While the disclosed embodiment has been described in the context of a Class 8 frontloading waste collection truck vehicle, embodiments can be designed for other vocational uses in other sized truck vehicles. By integrating a fuel pod with structure of a vocational body as shown, existing body structure may be sufficient to support the weight of a fuel pod. The fuel pod is more sheltered than at other locations and frees up space elsewhere in the vocational body and the vehicle chassis. The fuel pod doesn't contribute to vehicle height, or reduce vehicle road clearance, and it is out of the way of areas which are likely to be impacted by collisions.

What is claimed is:

1. A vocational truck vehicle comprising:
a cab-chassis having a chassis, a cab mounted on the chassis at a front of the vocational truck vehicle, the chassis including at least one rear axle rearward of the cab and a combustion engine for propelling the vocational truck vehicle;
a vocational body which is mounted on the chassis rearward of the cab, which overlies the at least one rear axle, and which has a rearward-facing wall; and
a fuel storage module for storing fuel for use by the combustion engine, the fuel storage module comprising a frame holding at least one fuel storage vessel and attached to the vocational body to locate the fuel storage module in confronting relation to the rearward-facing wall.

2. A vocational truck vehicle as set forth in claim 1 in which the fuel storage module is disposed on the vocational body at a location which places the fuel storage module rearward of the at least one rear axle.

3. A vocational truck vehicle as set forth in claim 2 in which the rearward-facing wall has an inclined surface which inclines downward in a direction away from the front of the vocational truck vehicle and the frame of the fuel storage module is disposed against and fastened to the inclined surface of the rearward-facing wall.

4. A vocational truck vehicle as set forth in claim 3 in which the frame of the fuel storage module comprises side member assemblies at opposite sides and the at least one fuel storage vessel comprises multiple fuel storage cylinders arranged with their long dimensions running between the side member assemblies.

5. A vocational truck vehicle as set forth in claim 4 in which some of the multiple fuel storage cylinders are arranged side-by-side in an underlying row and others of the multiple fuel storage cylinders are arranged side-by-side in an overlying row which overlies the underlying row and nests fuel storage cylinders of the overlying row between fuel storage cylinders of the underlying row.

6. A vocational truck vehicle as set forth in claim 5 further including a walled structure mounted on the vocational body to form a compartment within which the fuel storage module is disposed.

7. A vocational truck vehicle as set forth in claim 6 in which the walled structure comprises multiple access holes each proximate a valve at a lengthwise end of a respective fuel storage cylinder for providing hand access to a valve handle of a respective valve.

8. A vocational truck vehicle as set forth in claim 6 in which the rear wall of the vocational body comprises a tailgate which can be moved between a first position closing a discharge opening and a second position opening the discharge opening to allow contents of a storage compartment to be emptied through the discharge opening

9. A vocational truck vehicle as set forth in claim 8 in which the vocational body comprises a hopper at a front of the interior of the vocational body and a hopper opening through which material to be loaded into the interior of the vocational body can fall into the hopper, and a hopper loading mechanism operable to load material into the hopper through the hopper opening

10. A vocational truck vehicle as set forth in claim 9 including a door operable to open and close the hopper opening

11. A vocational truck vehicle as set forth in claim 3 further comprising for each fuel storage cylinder a respective shut-off valve having a first valve port fit to a port of a respective fuel storage cylinder in a sealed manner and additional ports connected by fuel lines placing the fuel storage cylinders in a chain so that when the shut-off valve of any fuel storage cylinder is open, the corresponding fuel storage cylinder is placed on-line to the chain.

12. A vocational truck vehicle as set forth in claim 11, each shut-off valve having a vent port which is normally closed, but opens to vent fuel from a fuel storage cylinder when in-cylinder pressure exceeds a pressure limit.

13. A vocational truck vehicle as set forth in claim 11 further including a walled structure mounted on the vocational body to form a compartment within which the fuel storage module, including the fuel storage cylinders and the shut-off valves, is disposed.
